(19) United States
(12) Patent Application Publication
(10) Pub. No.: US 2007/0169094 A1
(43) Pub. Date: Jul. 19, 2007

(54) Apparatus and method for permanently storing a broadcast program during time machine function

(75) Inventor: Eun Hyung Cho, Gyeongsangbuk-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/521,449

(22) Filed: Sep. 15, 2006

(30) Foreign Application Priority Data
Dec. 15, 2005 (KR) 10-2005-0123668

(51) Int. Cl. G06F 9/44

(52) U.S. Cl. 717/168

(57) ABSTRACT

An apparatus and method for permanently storing a broadcast program during time machine function is disclosed. An apparatus for permanently storing a program during a time machine function comprises a first memory for temporarily storing a plurality of programs, an on screen display (OSD) data generator for displaying OSD data on a screen, an address generator for generating a location information of the stored plurality of programs, a third memory for storing the location information of the stored plurality of the programs, and a controller for retrieving the location information of the program if the program is selected and for permanently storing the program at a second memory. Also, a method for permanently storing a program at a first memory during a time machine function comprises storing temporarily a plurality of programs according to the time machine function, selecting the program to store in the first memory, generating a location information of the plurality of programs, retrieving a location information of the program, and copying the program stored in the second memory to the first memory according to the location information of the selected program.

This application claims the benefit of Korean Patent Application No. 10-2005-0123668, filed on Dec. 15, 2005, which is hereby incorporated by reference.

### BACKGROUND OF THE INVENTION

1. Field of the Invention

The present invention relates to a display device, and more particularly, to a device for permanently storing a broadcast program during time machine function.

2. Discussion of the Related Art

The advancement of television technology made it possible to provide various functions in addition to receiving broadcast programs, thanks to the enhancing microprocessor and the increasing memory size. One of the various functions is a time machine (or time shift) function. The time machine function enables users to record the broadcast programs and play the recorded programs back at a later time. Moreover, the time machine function provides pause, backward, and forward play of broadcast programs in real time. For example, a television equipped with a time machine function using a personal video recorder (PVR) or a digital video recorder (DVR) has a hard disk drive for storing and replaying received broadcast programs as well as external input signals such as signals from a video player.

According to the conventional time machine function, a television is able to only temporarily store received programs, thereby erasing all the stored programs in the hard disk drive after ending the time machine function. Also, when a new program is started to be stored, the oldest program is erased because the time machine storage area is limited.

Therefore, it is highly desired to develop a technology which permanently stores broadcast programs by each program and/or by each program segment in order to reverse, fast forward, play, pause, index, fast/slow reverse play and fast/slow play the broadcast programs after ending the time machine function.

### SUMMARY OF THE INVENTION

Accordingly, the present invention is directed to an apparatus and method for permanently storing a broadcast program during time machine function that substantially obviates one or more problems due to the limitations and disadvantages of the related art.

An object of the present invention is to provide an apparatus and method for permanently storing a broadcast program by a program unit among a plurality of temporarily stored programs during time machine function.

Another object of the present invention is to provide an apparatus and method for permanently storing a user-selected broadcast program segment through the user interface among a plurality of temporarily stored programs during the time machine function.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for permanently storing a program during a time machine function comprises a first memory for temporarily storing a plurality of programs; an on screen display (OSD) data generator for displaying OSD data on a screen; an address generator for generating a location information of the stored plurality of programs; a third memory for storing the location information of the stored plurality of the programs; and a controller for retrieving the location information of the program if the program is selected and for permanently storing the program at a second memory.

In another aspect of the present invention, a method for permanently storing a program in a first memory during a time machine function comprises storing temporarily a plurality of programs according to the time machine function; selecting the program to store in the first memory; generating a location information of the plurality of programs; retrieving a location information of the program; and transferring the selected program stored in the second memory to the first memory according to the location information of the selected program.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further g of the invention and are incorporated in and constitute a part of this illustrate embodiment(s) of the invention and together with the description in the principle of the invention. In the drawings;

FIG. 1 illustrates a block schematic diagram of a television with a personal video recorder (PVR);

FIG. 2 illustrates a flowchart of the process of temporarily storing a program during the time machine function according to the embodiment of FIG. 1;

FIG. 3 illustrates a flowchart of the process of permanently storing a program during the time machine function according to the embodiment of FIG. 1;

FIG. 4A illustrates an enlarged view of the storage (126) in FIG. 1 showing a time machine storage area and permanent storage areas;

FIG. 4B illustrates a time machine recording table comprising time machine recording information.

FIG. 5 illustrates an on screen display (OSD) displaying a list of programs temporarily stored at the time machine storage area; and

FIG. 6 illustrates an OSD displaying the progress bar (PB).

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

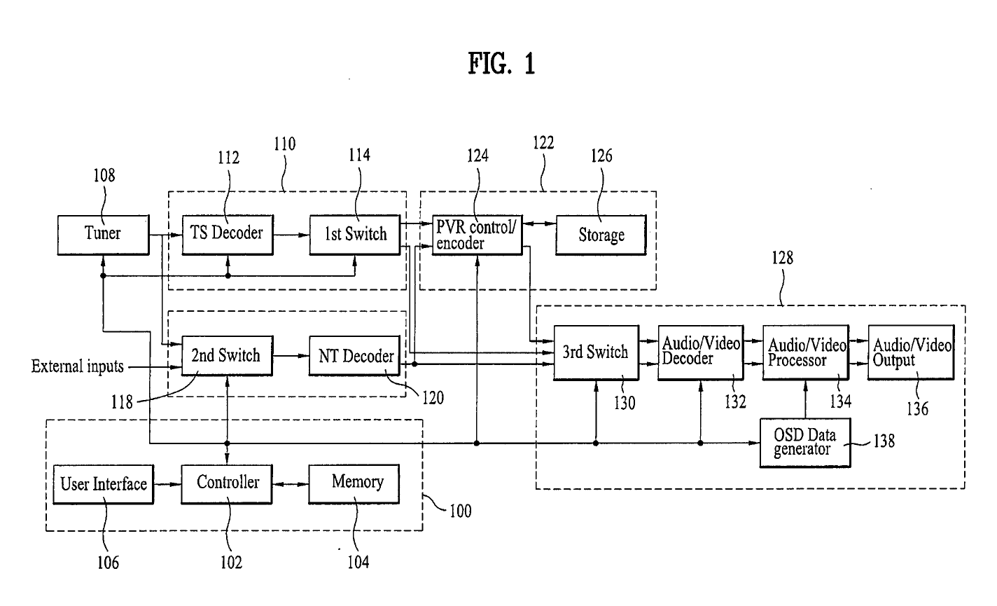

FIG. 1 shows a block schematic diagram of a television with a personal video recorder (PVR). The television comprises a controller device (100), a tuner (108) for searching a channel by the control of the controller device (100), a digital signal processor (110) for processing digital signals, an analog signal processor (116) for processing analog signals, a personal video recorder (PVR, 122) for saving and replaying the analog and/or digital signals, and a signal output part (128) for outputting signals from the analog signal processor, the digital signal processor, or the PVR.

The controller device (100) further comprises a controller (102), a memory (104) and a user interface (106). The controller (102) controls the general operations of the television and stores in the time machine recording table the time machine recording information containing the program information, the recording-start address and time, and the recording-end address and time of the broadcast programs stored in the time machine storage area (S1). The time machine recording table having the time machine recording information is updated whenever the channel or the program is changed.

Moreover, the controller controls the On Screen Display (OSD) data generator (138) for generating the OSD data displaying a list of the temporarily-stored plurality of programs. When a user selects a program which is displayed on the screen using the OSD data generator, the selected program is copied from the time machine storage area to one of permanent storage areas (S2). The controller stores the program according to the genre of the program.

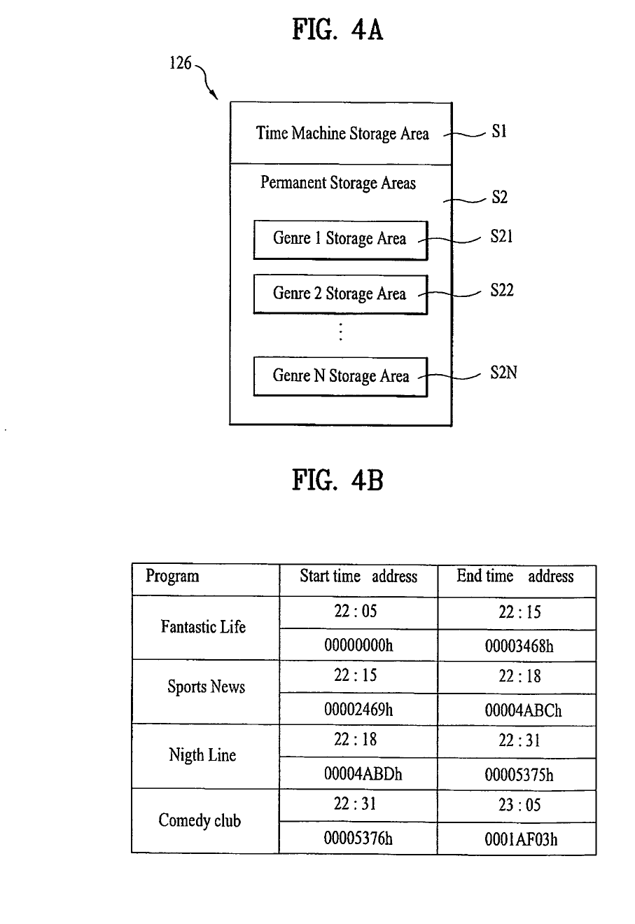

The memory (104) stores various information including processing commands of the controller. Specially, the memory (104) stores the time machine recording table comprising a plurality of time machine recording information. The time machine recording table contains titles, genres, program information, recording-start address and time, and recording-end address and time of the temporarily stored programs as shown in FIG. 4B.

The user interface (106) is an appropriate communication technology, such as keyboards, remote controls or keypad devices for providing commands or information from the user to the controller (102).

The tuner (108) searches a channel according to the control signal of the controller (102) and provides digital signal to digital signal processor (110) and analog signal to analog signal processor (116).

The digital signal processor (110) includes Transport Stream (TS) decoder (112) and the first switch (114). The TS decoder (112) decodes the digital signal from the tuner (108), transforms it to audio, video or data stream, and transmits it to the first switch (114).

The first switch (114) provides the audio, video or data stream from TS decoder (112) to PVR (122) and/or the signal output part (128).

The analog signal processor (116) includes the second switch and NT (National Television Standards Committee: NTSC) decoder (120).

The second switch (118) receives analog signals from the tuner (108) and/or from external input, and provides one of the two analog signals to NT (NTSC) decoder (120).

The NT decoder (120) decodes the analog signal from the tuner (108) or from the external input, transforms it to audio, video or data stream, and transmits it to the PVR part (122) or signal output part (128).

The PVR part (122) includes a PVR encoder (124) and storage (126). The PVR encoder (124) stores in the storage (126) the audio, video and data streams from the digital signal processor (110) according to a control signal of the controller (102), or stores the audio, video and data streams in the storage (126) by Moving Pictures Experts Group (MPEG)-encoding the audio and video signals from the analog signal processor (116).

The storage (126) stores audio, video and data streams from the PVR encoder (124) and is a hard disk drive including a hard disk. Especially, the hard disk of the storage (126) has a time machine storage area (S1) which temporarily stores programs during the time machine function and permanent storage areas (S2) which permanently stores user-selected programs. The permanent storage areas (S2) also has N areas (S21˜S2N) for storing programs by genres, for example drama, action, comedy, show, etc. as shown in FIG. 4A.

The addresses of the audio, video and data streams in the storage (126) are provided to the controller (102) by the PVR encoder (124).

The storage (126) actually stores audio, video and data streams received from broadcasting, and audio and video streams encoded with signals from external inputs. However, it is regarded for convenience that the storage (126) stores broadcast programs because the present invention guides by program by program.

The signal output part (128) includes the third switch (130), audio and video decoder (132), audio and video processor (133), audio and video output (136) and OSD generator (138).

The second switch (130) selects one of the outputs from the digital signal processor (110), analog signal processor (116) and PVR part (122), and provides the selected output to the audio and video decoder (132).

The audio and video decoder (132) decodes the audio and video streams into audio and video data if the input is the audio and video streams and provides it to the audio and video processor (134). If the input is the audio and video data, then the audio and video decoder (132) provides the audio and video data itself to the audio and video processor (134).

The audio and video processor (134) provides the audio and video data from the audio and video decoder (132) to the audio and video output (136).

Also, the audio and video processor (134) provides the video data mixed with the OSD data from the OSD generator (138) to the audio and video output (136).

The audio and video output (136) outputs the audio and video data from the audio and the video processor (134) using a display device and/or a speaker.

The OSD generator (138) generates OSD data according to a signal from a controller (102) and provides it to the audio and video processor (134).

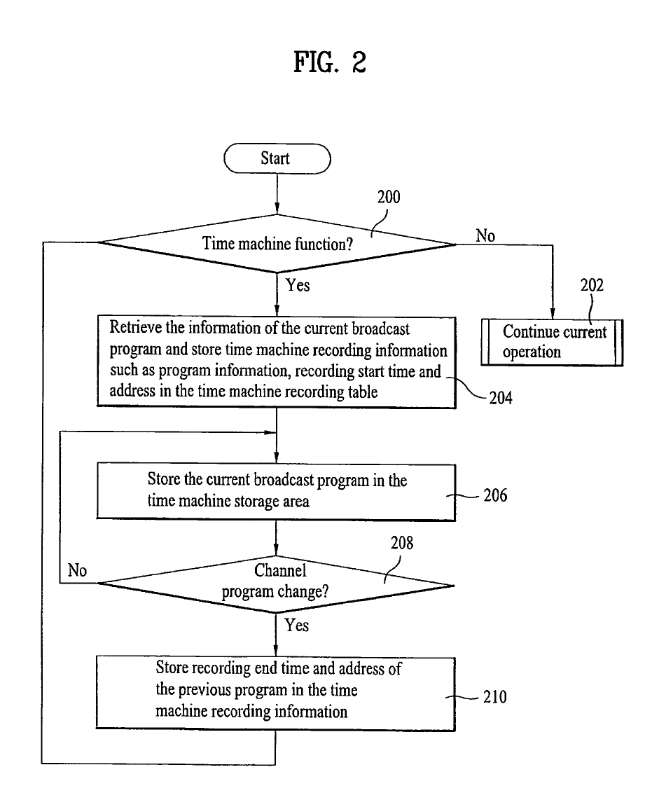

Turning now to FIG. 2, a flowchart is shown illustrating the process of recording a program during the time machine function according to the embodiment of FIG. 1.

In step 200, the controller (102) checks if the user performs the time machine function. If the user performs the time machine function, the controller (102) retrieves the information of the current broadcast program and stores time machine recording information such as program information and recording start address in the time machine recording table in step 204. It is to be noted that the program information may be obtained from Packet Identification (PID) and Electronic Program Guide (EPG). The EPG is a database containing information regarding broadcast schedules from various broadcast channels.

Also, the controller (102) controls the PVR encoder (124) in order to temporarily store the program at the time machine storage area (S1) during the time machine function in step 206.

In step 208, the controller checks if the user orders to change the channel or the television receives a different program in the same channel while storing the program.

The controller (102) stores the recording end time and the recording end address of the previous program in the time machine recording information when the user orders to change the channel or the television receives a different program in the same channel while storing the program in step 210.

After storing the recording end time and the recording end address of the previous program, the controller (102) goes back to step 200 and stores time machine recording information about the next program which the changed channel displays and the next program itself.

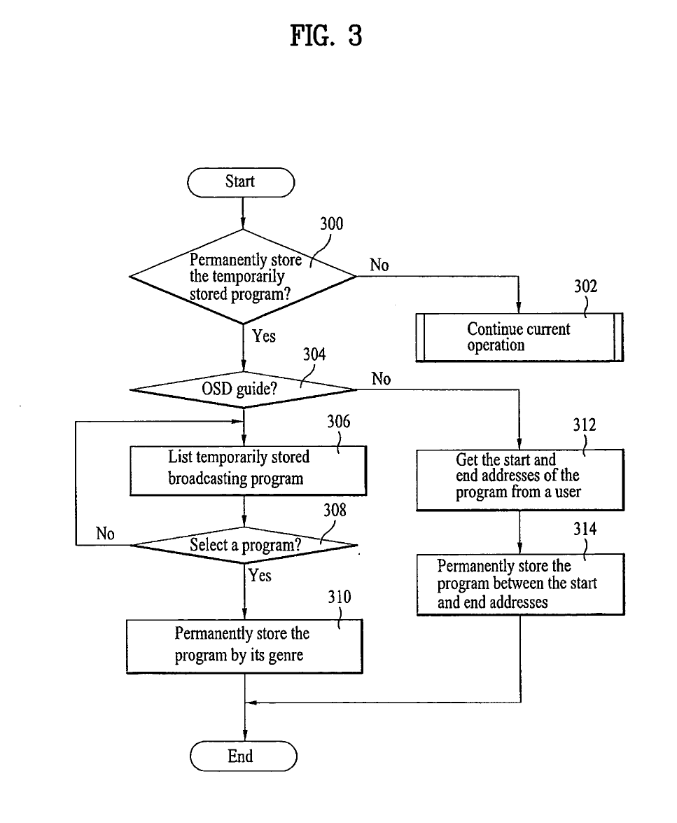

Turning now to FIG. 3, a flowchart is shown illustrating the process of permanently recording a program during the time machine function.

In step 300, the controller (102) checks if the user orders to permanently store the temporarily stored program according to time machine function through the user interface (106).

When the user orders to permanently store the temporarily stored program according to the time machine function through the user interface (106), the controller (102) outputs the OSD guide asking whether the program is selected automatically or by the user-input of the start and end addresses of the program in step 304.

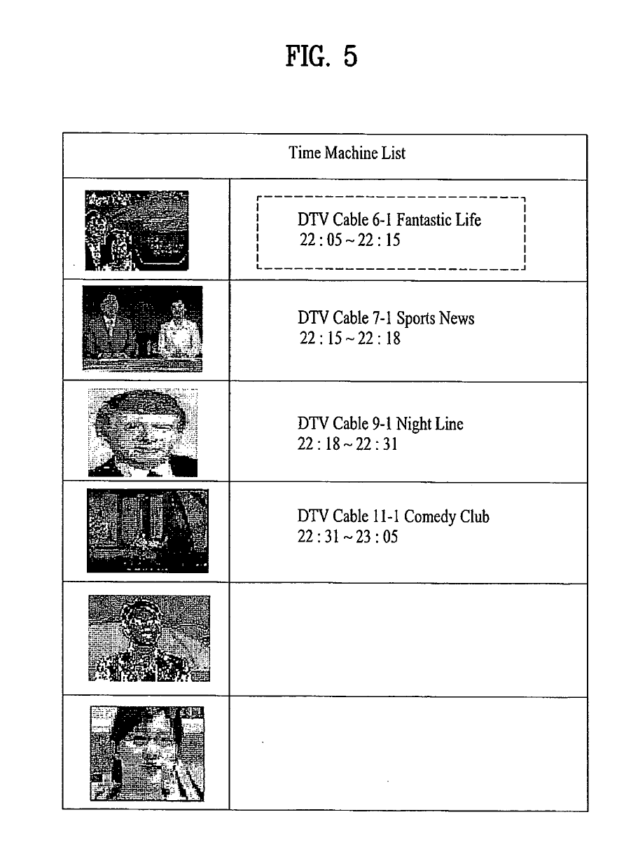

If the user chooses the automatic selection of the program according to the OSD guide, the controller (102) retrieves the time machine recording table from the memory (104) and controls the OSD generator (138) to generate the OSD data for showing the list of the broadcasting programs in the time machine storage area (S1) in step 306 as shown in FIG. 5.

In step 308, the controller (102) checks if the user wants to select one of the programs that the OSD shows. When the user selects one of the programs, the controller (102) retrieves the time machine recording information for the program from the memory (102) and finds start and end addresses of the program from the time machine recording information.

After finding the start and end addresses of the program, the controller (102) permanently stores the program at the memory according to the start and end addresses. Specially, the controller (102) stores the program according to its genre contained in the time machine recording information.

If the program is selected by the user-input of the start and end addresses of the program in step 304, the controller (102) gets the start and end addresses of the program from the user through the user interface (106) in step 312.

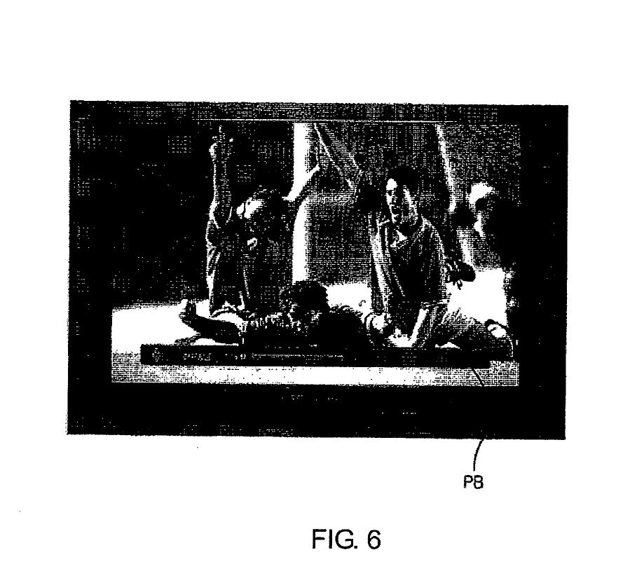

The start and end addresses which locate a program segment stored at the time machine recording information can be indicated on the progress bar (PB) which shows the location of the addresses as shown in FIG. 6.

After the start and end addresses of stored broadcasting program segment are given through the user interface (106), the controller (102) retrieves the program according to the start and end addresses, and permanently stores the program at the one of the permanent storage areas (S2) in step 314.

The invention makes it possible to permanently store a program among the temporarily stored programs during time machine function. Also, the invention makes it possible to permanently store a program segment through the user input among the temporarily stored program segments during time machine function.

While the invention has been described with respect to the physical embodiments constructed in accordance therewith, it will be apparent to those skilled in the art the various modifications, variations and improvements of the present invention can be made without departing from the spirit or scope of the inventions. Thus, it is intended that the present invention covers the modifications and variations of this invention provided they come within the scope of the appended claims and their equivalents.

What is claimed is:

1. An apparatus for permanently storing a program during a time machine function comprising:
a first memory for temporarily storing a plurality of programs;
an on screen display (OSD) data generator for displaying OSD data on a screen;
an address generator for generating a location information of the stored plurality of programs;
a third memory for storing the location information of the stored plurality of the programs; and
a controller for retrieving the location information of the program if the program is selected and for permanently storing the program at a second memory.

2. The apparatus of claim 1, further comprising a personal video recorder (PVR).

3. The apparatus of claim 2, wherein the PVR includes the first memory and the second memory.

4. The apparatus of claim 1, wherein a controller device comprises the controller, the third memory and a user interface which receives commands from a user.

5. The apparatus of claim 1, wherein the first memory includes a time machine recording table which contains a program information, a recording-start address and a recording-end address.

6. The apparatus of claim 5, wherein the time machine recording table is updated whenever a channel or the program is changed.

7. The apparatus of claim 1, wherein the controller controls the OSD data generator for generating the OSD data displaying a list of the temporarily-stored plurality of programs.

8. The apparatus of claim 1, wherein when a user selects a program which is displayed on the screen using the OSD data generator, the selected program is copied from the first memory to the second memory.

9. The apparatus of claim 1, wherein the controller stores the program according to a genre of the program.

10. The apparatus of claim 1, wherein the third memory stores various information including processing commands of the controller.

11. The apparatus of claim 10, wherein the third memory stores the time machine recording table comprising a plurality of time machine recording information.

12. The apparatus of claim 11, wherein the time machine recording table contains titles, genres, program information, recording-start addresses and recording-end addresses of the temporarily stored program.

13. The apparatus of claim 1, wherein a tuner searches a channel according to a control signal of the controller and provides digital signals to a digital signal processor and analog signals to an analog signal processor.

14. The apparatus of claim 1, wherein the second memory has a plurality of areas for storing programs by genres.

15. The apparatus of claim 13, further comprising a signal output part including a second switch, an audio and video decoder, an audio and video processor, an audio and video output and the OSD generator.

16. The apparatus of claim 15, wherein the second switch selects one of outputs from the digital signal processor, the analog signal processor and a PVR part, and provides the selected output to the audio and video decoder.

17. The apparatus of claim 16, wherein the audio and video decoder decodes audio and video streams into audio and video data if an input to the audio and video decoder is audio and video streams and provides the audio and video data to the audio and video processor.

18. The apparatus of claim 17, wherein the audio and video processor provides the audio and video data from the audio and video decoder to the audio and video output.

19. The apparatus of claim 17, wherein the audio and video processor provides the video data mixed with the OSD data from the OSD generator to the audio and video output.

20. The apparatus of claim 17, wherein the audio and video output outputs the audio and video data from the audio and the video processor using a display device and/or a speaker.

21. The apparatus of claim 17, wherein the OSD data generator generates OSD data according to a signal from the controller and provides the OSD data to the audio and video processor.

22. A method for permanently storing a program at a first memory during a time machine function comprising:
storing temporarily a plurality of programs according to the time machine function;
selecting the program to store in the first memory;
generating a location information of the plurality of programs;
retrieving a location information of the program; and
copying the program stored in the second memory to the first memory according to the location information of the selected program.

23. The method of claim 22, further comprising storing a program information of the program when the user changes the channel.

24. The method of claim 23, wherein the program information is obtained from Packet Identification (PID) and Electronic Program Guide (EPG).

25. The method of claim 22, further comprising storing a program information of the program when the channel displays another program.

26. The method of claim 25, wherein the program information is obtained from Packet Identification (PID) and Electronic Program Guide (EPG).

27. The method of claim 22, further comprising storing a program information of the program when an external input data is supplied.

28. The method of claim 27, wherein the program information is obtained from Packet Identification (PID) and Electronic Program Guide (EPG).

29. The method of claim 22, wherein if any address in the program is selected, then the controller automatically finds start and end addresses of the program and the program is permanently stored.

30. The method of claim 22, wherein the controller checks if the user orders to permanently store the temporarily stored program according to time machine function through a user interface.

31. The method of claim 30, wherein when the user orders to permanently store the temporarily stored program according to the time machine function through the user interface, the controller outputs the OSD guide asking whether the program is selected automatically or by the user-input of the start and end addresses of the program.

32. The method of claim 31, wherein if the user chooses automatic selection of the program according to the OSD guide, the controller retrieves the time machine recording table from the memory and controls the OSD generator to generate the OSD data for showing the list of the broadcasting programs in the time machine storage area.

33. The method of claim 32, wherein the controller checks if the user wants to select one of the programs that an OSD shows.

34. The method of claim 33, wherein when the user selects one of the programs that the OSD shows, the controller retrieves the time machine recording information for the program from the memory and finds start and end addresses of the program from the time machine recording information.

35. The method of claim 34, wherein after finding the start and end addresses of the program, the controller permanently stores the program at the memory according to the start and end addresses.

36. The method of claim 35, wherein the controller stores the program according to a genre of the program contained in the time machine recording information.

37. The method of claim 36, wherein if the program is selected by the user-input of the start and end addresses of the program, the controller gets the start and end addresses of the program from the user through the user interface.

38. The method of claim 37, wherein after the start and end addresses of stored broadcasting program segment are given through the user interface, the controller retrieves the program according to the start and end addresses, and permanently stores the program at the memory.
